(19) United States
(12) Patent Application Publication
(10) Pub. No.: US 2026/0222119 A1
(43) Pub. Date: Jul. 30, 2026

(54) COMMUNICATION METHOD USING LOW-RELIABILITY NETWORK PROTOCOL, AND COMMUNICATION SYSTEM SUPPORTING SAME

(71) Applicant: INDUSTRY-ACADEMIC COOPERATION FOUNDATION GYEONGSANG NATIONAL UNIVERSITY, Jinju-si (KR)

(72) Inventors: Seong Jin Lee, Jinju-si (KR); Chang Hui Kim, Gimhae-si (KR)

(73) Assignee: INDUSTRY-ACADEMIC COOPERATION FOUNDATION GYEONGSANG NATIONAL UNIVERSITY, Jinju-si (KR)

(21) Appl. No.: 19/148,873

(22) PCT Filed: Jan. 9, 2024
(86) PCT No.: PCT/KR2024/000395

§ 371 Date: Jul. 17, 2025

(30) Foreign Application Priority Data
Jan. 19, 2023 (KR) 10-2023-0008048

(51) Int. Cl. H04L 1/1607; H04L 1/00; H04L 5/00

(52) U.S. Cl. CPC H04L 1/1664; H04L 1/0034; H04L 5/0055

(57) ABSTRACT

A communication system using a low-reliability network protocol includes a receiving device configured to check whether at least one of a plurality of first packets has been received from a transmitting device, and to transmit, based on a result of the check, a second packet including a Not Acknowledgement (NACK) signal to the transmitting device. The second packet includes predetermined header data, and the predetermined header data includes at least one of a first field, a second field, and a third field. The first field indicates whether one of the plurality of first packets has been received from the transmitting device. The second field indicates a value that is incremented or maintained depending on whether said one of the first packets has not been received from the transmitting device. The third field indicates a value that is incremented upon reception of another one of the plurality of first packets from the transmitting device. Various other embodiments understood from this disclosure are also possible.

### TECHNICAL FIELD

The embodiments disclosed herein relate to a communication method using a low-reliability network protocol and a communication system supporting the same.

### BACKGROUND ART

The Internet of Things (IoT) refers to a technology or environment in which objects connected via a network exchange data in real time. The connected objects can communicate with each other and exchange information without user intervention.

Network communication between objects may be performed based on a protocol. For example, network communication between a transmitting device and a receiving device may be performed based on the User Datagram Protocol (UDP). UDP can support high-speed data communication. However, UDP may not control the data transmission rate even when network congestion occurs due to increased network usage. In such a case, overall network usage may be maintained or even increased, eventually causing long-term disruption to the network.

In order to reduce network disruption caused by UDP, the Fair Datagram Protocol (FDP) may be used.

Unlike UDP, FDP can reduce network load by adjusting the data transmission rate according to the network conditions. For example, FDP may autonomously adjust the data transmission rate depending on the network state within a specified range of transmission rates. In addition, FDP may adjust the transmission rate using features such as Not Acknowledgement (NACK) and heartbeat (HB). When the NACK feature is used, FDP may transmit a NACK signal from a data receiving device (e.g., a server) to a data transmitting device (e.g., a client) upon detecting a packet loss. The data transmitting device may reduce the transmission rate in response to receiving the NACK signal. When the HB feature is used, FDP may reduce the data transmission rate based on the communication status between the data transmitting device and the data receiving device.

### DETAILED DESCRIPTION OF THE INVENTION

### Technical Problem

However, when a large volume of data is transmitted and received over a certain period of time, FDP may not clearly provide a mechanism for when and how to generate and deliver NACK signals and/or HB signals.

Accordingly, various embodiments disclosed herein may provide a communication method using a low-reliability network protocol and a communication system supporting the same, which include a protocol structure for stably adjusting the data transmission rate.

### Solution to the Problem

According to an embodiment, a communication system using a low-reliability network protocol includes a network; and a receiving device communicatively connected to a transmitting device via the network. The receiving device is configured to check whether at least one of a plurality of first packets has been received from the transmitting device; and transmit, based on a result of the check, a second packet including a Not Acknowledgement (NACK) signal to the transmitting device. The second packet includes predetermined header data, and the predetermined header data includes at least one of a first field, a second field, and a third field. The first field indicates whether one of the plurality of first packets has been received from the transmitting device; the second field indicates a value that is either incremented or maintained depending on whether said one of the first packets has not been received from the transmitting device; and the third field indicates a value that is incremented upon reception of another one of the plurality of first packets from the transmitting device to the receiving device.

According to an embodiment, the receiving device may be configured to check whether said one of the first packets has been received from the transmitting device, based on reception of another one of the first packets from the transmitting device after said one of the first packets has not been received from the transmitting device.

According to an embodiment, the receiving device may be configured to check, after transmitting a second packet including a second field corresponding to a first value to the transmitting device due to a failure to receive said one of the first packets from the transmitting device, whether a first packet including a field corresponding to the first value has been received from the transmitting device, and, based on a result of the check, either increment the first value in the second field to a second value greater than the first value, or maintain the first value in the second field.

According to an embodiment, the receiving device may be configured to, when said one of the first packets from the transmitting device is not received, transmit the second packet to the transmitting device at least twice within a specified interval.

According to an embodiment, the transmitting device may be configured to treat, among the second packets transmitted at least twice from the receiving device, a second packet that is first received within the specified interval as a valid packet.

According to an embodiment, the transmitting device may be configured to treat, among the second packets transmitted at least twice from the receiving device, second packets other than the second packet treated as the valid packet as invalid packets.

According to an embodiment, the transmitting device may be configured to adjust a data communication rate for at least one of the plurality of first packets based on whether the second packet has been received from the receiving device.

According to an embodiment, the predetermined header data may further includes a fourth field, and the fourth field may indicate a communication state between the transmitting device and the receiving device.

According to an embodiment, a communication method using a low-reliability network protocol includes: checking whether at least one of a plurality of first packets has been received from a transmitting device to a receiving device via a network; and transmitting, based on a result of the check, a second packet including a Not Acknowledgement (NACK) signal from the receiving device to the transmitting device. The second packet includes predetermined header data, and the predetermined header data includes at least one of a first field, a second field, and a third field. The first field indicates whether one of the plurality of first packets has been received from the transmitting device to the receiving device; the second field indicates a value that is either incremented or maintained depending on whether said one of the first packets has not been received from the transmitting device to the receiving device; and the third field indicates a value that is incremented upon reception of another one of the plurality of first packets from the transmitting device to the receiving device.

According to an embodiment, the checking of whether at least one of the plurality of first packets has been received may include: checking, based on reception of another one of the first packets from the transmitting device to the receiving device after said one of the first packets has not been received, whether said one of the first packets has been received from the transmitting device to the receiving device.

According to an embodiment, the communication method using a low-reliability network protocol may further include: checking, after transmission of, from the receiving device to the transmitting device, a second packet including a second field corresponding to a first value due to a failure to receive one of the first packets from the transmitting device to the receiving device, whether a first packet including a field corresponding to the first value has been received from the transmitting device to the receiving device; and based on a result of the check, either incrementing the first value in the second field to a second value greater than the first value or maintaining the first value in the second field.

According to an embodiment, the communication method using a low-reliability network protocol may further include: transmitting, when one of the first packets is not received from the transmitting device to the receiving device, the second packet from the receiving device to the transmitting device at least twice within a specified interval.

According to an embodiment, the transmitting of the second packet at least twice to the transmitting device may include: treating, among the second packets transmitted at least twice from the receiving device to the transmitting device, a second packet that is first received within the specified interval as a valid packet.

According to an embodiment, the transmitting of the second packet at least twice to the transmitting device may include: treating, among the second packets transmitted at least twice from the receiving device to the transmitting device, second packets other than the second packet treated as the valid packet as invalid packets.

According to an embodiment, the communication method using a low-reliability network protocol may further include: adjusting a data transmission rate for at least one of the plurality of first packets based on whether the second packet has been received from the receiving device to the transmitting device.

According to an embodiment, the predetermined header data may further include a fourth field, and the fourth field may indicate a communication state between the transmitting device and the receiving device.

### Effects of the Invention

A communication method using a low-reliability network protocol and a communication system supporting the same according to various embodiments disclosed herein may improve the efficiency of FDP by including a protocol structure for stably adjusting the data transmission rate.

In addition, according to various embodiments disclosed herein, problems caused by network congestion may be reduced by improving the efficiency of FDP.

Furthermore, various effects that can be directly or indirectly understood from the present disclosure may also be provided.

### BRIEF DESCRIPTION OF THE DRAWINGS

FIG. 1 is a block diagram of a communication system using a low-reliability network protocol according to an embodiment of the present disclosure.

FIG. 2 is a flowchart illustrating a packet structure of a low-reliability network protocol according to an embodiment of the present disclosure.

FIG. 3 is a diagram schematically illustrating a packet transmission and reception process between a transmitting device and a receiving device according to various embodiments in a sequential order.

FIG. 4 is a diagram illustrating operations of a transmitting device and a receiving device as an algorithm according to an embodiment of the present disclosure.

FIG. 5 is a diagram illustrating operations of a transmitting device as an algorithm in a case where communication between the transmitting device and the receiving device is unstable, according to an embodiment of the present disclosure.

FIG. 6 is a diagram schematically illustrating a packet transmission and reception process between a transmitting device and a receiving device according to various embodiments in a sequential order.

FIG. 7 is a flowchart of a communication method using a low-reliability network protocol according to an embodiment of the present disclosure.

### BEST MODE FOR CARRYING OUT THE INVENTION

Hereinafter, preferred embodiments of the present invention will be described in detail with reference to the accompanying drawings. The advantages and features of the present invention, and methods for achieving them, will become apparent from the embodiments described in detail below with reference to the accompanying drawings. However, the present invention is not limited to the embodiments disclosed below, but may be implemented in various different forms. The embodiments are provided merely to ensure a complete disclosure of the present invention and to fully convey the scope of the invention to those skilled in the art. The present invention is defined only by the scope of the claims. In the following description, like reference numerals denote like components.

Although terms such as first, second, and the like may be used to describe various elements, components, and/or sections, such terms are not intended to limit the elements, components, and/or sections. These terms are merely used to distinguish one element, component, or section from another. Thus, a first element, component, or section described below may also be referred to as a second element, component, or section within the technical scope of the present invention.

The terminology used in this specification is for the purpose of describing particular embodiments only and is not intended to limit the scope of the invention. As used herein, the singular forms also include the plural forms unless the context clearly indicates otherwise. The terms “comprises” and/or “made of” used in the specification do not exclude the presence or addition of one or more other elements, steps, operations, and/or components.

Unless otherwise defined, all terms used herein (including technical and scientific terms) have the same meaning as commonly understood by one of ordinary skill in the art to which the present invention pertains. Terms generally defined in commonly used dictionaries should be interpreted as having a meaning that is consistent with their meaning in the context of the relevant art and are not to be interpreted in an overly idealized or excessively formal sense unless explicitly defined otherwise.

Hereinafter, the configuration of the present invention will be described in detail with reference to the accompanying drawings.

FIG. 1 is a block diagram of a communication system using a low-reliability network protocol according to an embodiment of the present disclosure.

Referring to FIG. 1, a communication system 100 using a low-reliability network protocol according to an embodiment of the present disclosure (hereinafter referred to as “communication system 100”) may include a transmitting device 110 and a receiving device 120. In one embodiment, the transmitting device 110 and the receiving device 120 may be connected to each other via a network 101.

According to an embodiment, the transmitting device 110 may transmit a plurality of first packets to the receiving device 120. For example, the transmitting device 110 may transmit packets including various data to the receiving device 120 within a specified interval (e.g., one minute) via the network 101.

According to an embodiment, the transmitting device 110 may adjust a data transmission rate for at least one of the plurality of first packets based on whether a second packet is received from the receiving device 120. For example, if the transmitting device 110 transmits a first packet to the receiving device 120 at a first time and then receives a second packet including a NACK (Not Acknowledgement) signal from the receiving device 120 at a second time, the transmitting device 110 may reduce the data transmission rate for first packets to be transmitted to the receiving device 120 after the second time to a rate lower than the data transmission rate at the first time.

According to an embodiment, the transmitting device 110 may treat, as a valid packet, the second packet received at the earliest time (e.g., the first time) among second packets transmitted at least twice from the receiving device 120 within a specified interval (e.g., one minute). In addition, the transmitting device 110 may treat the remaining second packets, other than the one determined to be valid, as invalid packets.

According to an embodiment, the receiving device 120 may check whether at least one of a plurality of first packets has been received from the transmitting device 110. For example, if one of the first packets is not received, and another first packet is subsequently received from the transmitting device 110, the receiving device 120 may check whether the previously unreceived first packet has been received based on the reception of the subsequent packet.

According to an embodiment, the receiving device 120 may transmit a second packet including a NACK signal to the transmitting device 110 based on whether at least one first packet has been received. For example, if a first packet is not received at a first time during a specified interval (e.g., 60 seconds) and another first packet is received at a second time thereafter, the receiving device 120 may notify the transmitting device 110 that the first packet was missing at the first time using a predetermined packet structure including a NACK signal.

According to an embodiment, the receiving device 120 may transmit a second packet to the transmitting device 110 that includes a field value that is equal to or greater than a portion of a field value of a first packet received from the transmitting device 110, based on whether a partial field value of the second packet transmitted from the receiving device 120 to the transmitting device 110 corresponds to a partial field value of a first packet transmitted from the transmitting device 110 to the receiving device 120.

According to an embodiment, if the receiving device 120 fails to receive one of the plurality of first packets from the transmitting device 110, it may transmit the second packet at least twice to the transmitting device 110 within a specified interval (e.g., 60 seconds).

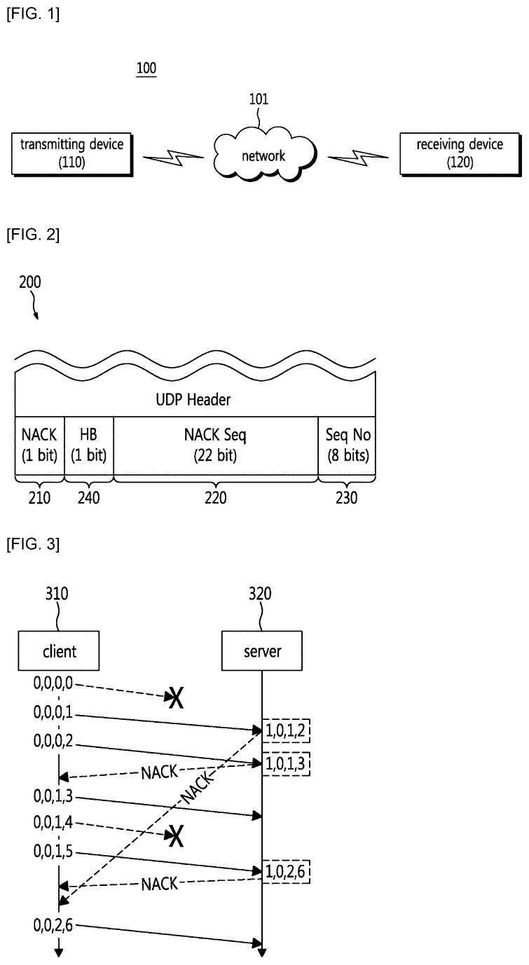

According to an embodiment, the receiving device 120 may include a predetermined packet structure. The predetermined packet structure (e.g., packet structure 200 of FIG. 2) may include header data. The header data may include a first field (e.g., first field 210 of FIG. 2), a second field (e.g., second field 220 of FIG. 2), a third field (e.g., third field 230 of FIG. 2), and a fourth field (e.g., fourth field 240 of FIG. 2). In one embodiment, the receiving device 120 may represent a packet transmission and reception state with the transmitting device 110 based on the field values assigned to the first through fourth fields 210 to 240. Detailed information related to the packet structure 200 may be understood with reference to FIG. 2.

FIG. 2 is a flowchart illustrating a packet structure of a low-reliability network protocol according to an embodiment of the present disclosure.

Referring to FIG. 2, a packet structure 200 of a low-reliability network protocol according to an embodiment of the present disclosure (hereinafter referred to as “packet structure 200”) may be based on FDP implemented over UDP.

According to an embodiment, the packet structure 200 may include a first field 210, a second field 220, a third field 230, and a fourth field 240.

In one embodiment, the first field 210 may indicate whether one of the plurality of first packets from the transmitting device 110 has been received. For example, the first field 210 may be a bit specifying a NACK message and may represent the reception status of the first packet using a value of either 0 or 1. In one embodiment, the first field 210 may also be used to distinguish between a first packet and a second packet.

In one embodiment, the second field 220 may indicate a value that increases or remains unchanged depending on whether one of the plurality of first packets from the transmitting device 110 has not been received. For example, the second field 220 may be a 22-bit field indicating a NACK sequence and may represent the number of NACK message transmissions using a value of 0 or a positive integer.

In one embodiment, the third field 230 may indicate a value that increases as another one of the plurality of first packets from the transmitting device 110 is received. For example, the third field 230 may be an 8-bit field indicating a packet sequence and may represent the number of packet transmissions and receptions using a value of 0 or a positive integer. In one embodiment, the third field 230 may be initialized at a specified interval. For example, the third field 230 may be incremented from a value corresponding to 0 up to a value corresponding to 255 according to the number of packet transmissions and receptions, and then reset to the value corresponding to 0.

In one embodiment, the fourth field 240 may indicate a communication status between the transmitting device 110 and the receiving device 120. For example, the fourth field 240 may be a bit specifying a heartbeat (HB) message and may indicate the communication status between the transmitting device 110 and the receiving device 120 using a value of either 0 or 1.

FIG. 3 is a diagram illustratively showing, in a sequence of steps, a packet transmission and reception process between a transmitting device and a receiving device according to various embodiments.

Referring to FIG. 3, a communication system 100 according to various embodiments may enable a transmitting device 310 to adjust a data transmission rate using four field values in a packet header.

According to an embodiment, the transmitting device 310 may omit the packet (0, 0, 0, 0) transmitted to a receiving device 320 at a first time point. Upon detecting this, the receiving device 320 may generate a new NACK, i.e., NACK (1, 0, 1, 2). In NACK (1, 0, 1, 2), the first field (e.g., first field 210) may have a value of 1 to indicate that the packet includes a NACK signal. In NACK (1, 0, 1, 2), the third field (e.g., second field 220) may increment the NACK sequence from a value of 0 to a value of 1. In NACK (1, 0, 1, 2), the fourth field (e.g., third field 230) may increment the packet sequence to a value (e.g., 2) greater than the sequence number (e.g., 1) of the most recently received packet.

According to an embodiment, the receiving device 320 may check whether the NACK sequence of a packet received from the transmitting device 310 after the first time point is synchronized with the NACK sequence included in the packet of the receiving device 320. If the NACK sequences are not synchronized, the receiving device 320 may retransmit a NACK with the same NACK sequence. After issuing NACK (1, 0, 1, 2), the receiving device 320 may receive packet (0, 0, 0, 2) from the transmitting device 310. Since the NACK sequence is not synchronized to 1, the receiving device 320 may transmit NACK (1, 0, 1, 3), which has the same NACK sequence, to the transmitting device 310.

According to an embodiment, the receiving device 320 may transmit multiple NACKs with the same NACK sequence in response to a single packet omission. The transmitting device 310 may ignore delayed NACKs among those transmitted by the receiving device 320. For example, the transmitting device 310 may ignore NACK (1, 0, 1, 2) that arrives late from the receiving device 320 because the transmitting device 310 is already operating with NACK sequence 2.

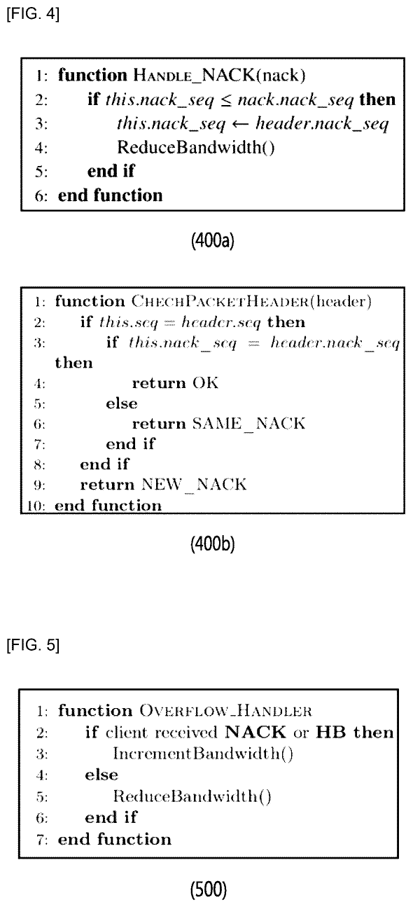

FIG. 4 is a diagram illustrating the operations of a transmitting device and a receiving device as algorithms according to an embodiment. FIG. 4 may illustrate the process of FIG. 3 as a first algorithm 400a and a second algorithm 400b, respectively.

Referring to the first algorithm 400a, it may represent operations performed by a transmitting device 110 when a NACK is received. The transmitting device 110 may ignore a NACK having a NACK sequence value smaller than its own NACK sequence, based on specified conditions. The specified condition is illustrated in the second line of the first algorithm 400a. The transmitting device 110 may synchronize the NACK sequence with the received NACK that meets the specified condition and reduce the data transmission rate by half.

Referring to the second algorithm 400b, it may represent a process in which the receiving device 120 analyzes header data of a first packet received from the transmitting device 110. Based on the analysis of the header data, the receiving device 120 may determine one of the following three states.

A first state is an OK state, in which the sequence count according to the transmission and reception of the packets has no omissions, and the NACK sequence is synchronized with the receiving device 120.

A second state is a SAME_NACK state, in which the sequence count has no omissions but the NACK sequence is not synchronized with the receiving device 120. In this state, the receiving device 120 may retransmit a NACK having the same NACK sequence so that the transmitting device 110 can synchronize the NACK sequence.

A third state is a NEW_NACK state, in which the sequence count according to the transmission and reception of packets is missing. In this case, the receiving device 120 may generate a new NACK and transmit it to the transmitting device 110.

### MODE FOR CARRYING OUT THE INVENTION

FIG. 5 is a diagram illustrating the operation of a transmitting device as an algorithm in a case where the communication state between the transmitting device and a receiving device is unstable, according to an embodiment.

The packet transmission and reception process illustrated in FIG. 3 may represent a situation in which a NACK is transmitted from a receiving device 320 to a transmitting device 310 under normal communication conditions. However, under abnormal communication conditions, such as a network failure, a NACK may not be transmitted from the receiving device 320 to the transmitting device 310. To prevent this, the FDP may perform a heartbeat (HB) mechanism. The HB mechanism is configured to verify the communication functionality between the transmitting device 110 and the receiving device 120, and may be performed each time the sequence count for packet transmission and reception is reset on a 256-cycle basis.

According to an embodiment, when performing the HB, the transmitting device 110 may check whether there is any packet received from the receiving device 120 during the current cycle. If the transmitting device 110 has received any packet from the receiving device 120, the HB is considered successful (condition 2 in FIG. 5). In this case, the transmitting device 110 may increase the data communication speed by 1 kbyte/s. Conversely, if the transmitting device 110 has not received any packet from the receiving device 120, the HB is considered failed, and the transmitting device 110 may reduce the data communication speed by half.

In an exceptional case, all 256 packets (0 to 255) transmitted by the transmitting device 110 during one cycle may be successfully received by the receiving device 120 without any loss. In such a case, the receiving device 120 may not transmit even a single NACK to the transmitting device 110. Therefore, the transmitting device 110 may regard the HB as failed despite the fact that communication with the receiving device 120 has been smoothly carried out. To prevent this, the receiving device 120 may transmit a HB packet (e.g., the fourth packet 240 in FIG. 2) to the transmitting device 110 during the HB operation.

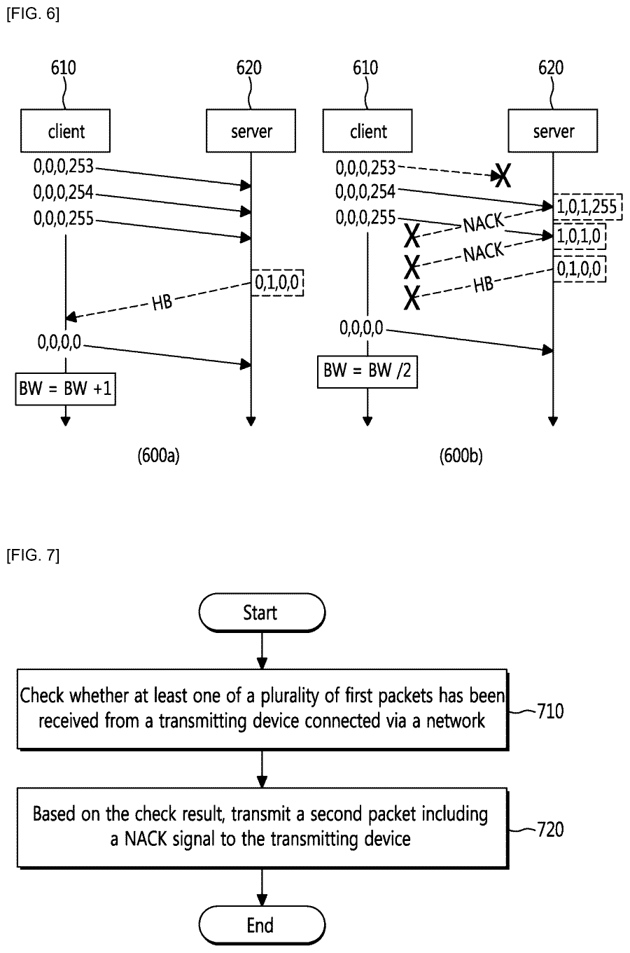

FIG. 6 is a diagram showing, as an example, a sequence of steps representing packet transmission and reception between a transmitting device and a receiving device, according to various embodiments.

A first process 600a may represent an example in which the heartbeat (HB) is successful. In the first process 600a, a transmitting device 610 may not receive any NACK during one cycle. This can be inferred from the fact that the NACK sequence of the packets transmitted by the transmitting device 610 remains at its initial value of 0. Accordingly, the HB packet transmitted by a receiving device 620 may reach the transmitting device 610, thereby resulting in a successful HB.

A second process 600b may represent an example in which the HB fails. Some of the packets transmitted by the transmitting device 610 may be lost, and multiple NACKs may be transmitted. However, none of the NACKs may reach the transmitting device 610. This can be inferred from the fact that the NACK sequence of the transmitting device 610 remains at the initial value of 0. In addition, the HB packet transmitted by the receiving device 620 at the end may also be lost, such that the transmitting device 610 may not receive any packets from the receiving device 620 during the entire cycle. Accordingly, the HB may fail, and the transmitting device 610 may reduce the data communication speed by half.

FIG. 7 is a flowchart illustrating a communication method using a low-reliability network protocol according to an embodiment.

Referring to operation 710, a receiving device 120 may check whether at least one of a plurality of first packets has been received from a transmitting device 110. For example, if a certain one of the first packets is initially not received from the transmitting device 110, the receiving device 120 may determine whether the missing packet was eventually received, based on the subsequent reception of another first packet from the transmitting device 110.

Referring to operation 720, the receiving device 120 may transmit a second packet including a NACK signal to the transmitting device 110 based on whether at least one first packet has been received. For instance, if no first packet is received at a first time point within a specified interval (e.g., 60 seconds), and another first packet is subsequently received at a second time point, the receiving device 120 may notify the transmitting device 110 of the omission of the first packet at the first time point using a predetermined packet structure that includes a NACK signal.

According to an embodiment, the receiving device 120 may transmit a second packet to the transmitting device 110, the second packet including a partial field value that is equal to or greater than a corresponding partial field value, based on whether a partial field value of the second packet (transmitted from the receiving device 120 to the transmitting device 110) corresponds to a partial field value of a first packet transmitted from the transmitting device 110 to the receiving device 120.

According to an embodiment, if one of a plurality of first packets transmitted from the transmitting device 110 is not received, the receiving device 120 may transmit a second packet to the transmitting device 110 at least twice within a specified interval (e.g., 60 seconds).

In the description of the drawings, the same or corresponding elements may be assigned the same reference numerals.

While the invention has been described with reference to the illustrated embodiments, these embodiments are merely exemplary and not limiting. It will be apparent to those of ordinary skill in the art that various modifications, changes, and equivalent alternatives may be made without departing from the spirit and scope of the invention. Accordingly, the true technical scope of the present invention should be defined by the technical spirit of the appended claims.

### INDUSTRIAL APPLICABILITY

The present invention is applicable to Internet of Things (IoT) networks.

What is claimed is:

1. A communication system using a low-reliability network protocol, comprising:
a network; and
a receiving device communicatively connected to a transmitting device via the network,
wherein the receiving device is configured to:
check whether at least one of a plurality of first packets has been received from the transmitting device; and
transmit, based on a result of the check, a second packet including a Not Acknowledgement (NACK) signal to the transmitting device,
wherein the second packet includes predetermined header data,
the predetermined header data including at least one of a first field, a second field, and a third field,
wherein:
the first field indicates whether one of the plurality of first packets has been received from the transmitting device,
the second field indicates a value that is either incremented or maintained depending on whether said one of the first packets has not been received from the transmitting device; and
the third field indicates a value that is incremented upon reception of another one of the plurality of first packets from the transmitting device to the receiving device.

2. The communication system of claim 1,
wherein the receiving device is configured to check whether said one of the first packets has been received from the transmitting device, based on reception of another one of the first packets from the transmitting device after said one of the first packets has not been received from the transmitting device.

3. The communication system of claim 1,
wherein the receiving device is configured to:
check, after transmitting a second packet including a second field corresponding to a first value to the transmitting device due to a failure to receive said one of the first packets from the transmitting device, whether a first packet including a field corresponding to the first value has been received from the transmitting device, and
based on a result of the check, either increment the first value in the second field to a second value greater than the first value, or maintain the first value in the second field.

4. The communication system of claim 1,
wherein the receiving device is configured to, when said one of the first packets from the transmitting device is not received, transmit the second packet to the transmitting device at least twice within a specified interval.

5. The communication system of claim 4,
wherein the transmitting device is configured to treat, among the second packets transmitted at least twice from the receiving device, a second packet that is first received within the specified interval as a valid packet.

6. The communication system of claim 5,
wherein the transmitting device is configured to treat, among the second packets transmitted at least twice from the receiving device, second packets other than the second packet treated as the valid packet as invalid packets.

7. The communication system of claim 1,
wherein the transmitting device is configured to adjust a data communication rate for at least one of the plurality of first packets based on whether the second packet has been received from the receiving device.

8. The communication system of claim 1,
wherein the predetermined header data further includes a fourth field, and
wherein the fourth field indicates a communication state between the transmitting device and the receiving device.

9. A communication method using a low-reliability network protocol, the method comprising:
checking whether at least one of a plurality of first packets has been received from a transmitting device to a receiving device via a network; and
transmitting, based on a result of the check, a second packet including a Not Acknowledgement (NACK) signal from the receiving device to the transmitting device,
wherein the second packet includes predetermined header data,
the predetermined header data including at least one of a first field, a second field, and a third field,
wherein:
the first field indicates whether one of the plurality of first packets has been received from the transmitting device to the receiving device;
the second field indicates a value that is either incremented or maintained depending on whether said one of the first packets has not been received from the transmitting device to the receiving device; and
the third field indicates a value that is incremented upon reception of another one of the plurality of first packets from the transmitting device to the receiving device.

10. The communication method of claim 9,
wherein the checking of whether at least one of the plurality of first packets has been received comprises:
checking, based on reception of another one of the first packets from the transmitting device to the receiving device after said one of the first packets has not been received, whether said one of the first packets has been received from the transmitting device to the receiving device.

11. The communication method of claim 9, further comprising:
checking, after transmission of, from the receiving device to the transmitting device, a second packet including a second field corresponding to a first value due to a failure to receive one of the first packets from the transmitting device to the receiving device, whether a first packet including a field corresponding to the first value has been received from the transmitting device to the receiving device; and
based on a result of the check, either incrementing the first value in the second field to a second value greater than the first value or maintaining the first value in the second field.

12. The communication method of claim 9, further comprising:
transmitting, when one of the first packets is not received from the transmitting device to the receiving device, the second packet from the receiving device to the transmitting device at least twice within a specified interval.

13. The communication method of claim 12,
wherein the transmitting of the second packet at least twice to the transmitting device comprises:
treating, among the second packets transmitted at least twice from the receiving device to the transmitting device, a second packet that is first received within the specified interval as a valid packet.

14. The communication method of claim 13,
wherein the transmitting of the second packet at least twice to the transmitting device comprises:
treating, among the second packets transmitted at least twice from the receiving device to the transmitting device, second packets other than the second packet treated as the valid packet as invalid packets.

15. The communication method of claim 9, further comprising:
adjusting a data transmission rate for at least one of the plurality of first packets based on whether the second packet has been received from the receiving device to the transmitting device.

16. The communication method of claim 9,
wherein the predetermined header data further includes a fourth field, and
wherein the fourth field indicates a communication state between the transmitting device and the receiving device.
